(19) United States
(12) Patent Application Publication
(10) Pub. No.: US 2026/0091490 A1
(43) Pub. Date: Apr. 2, 2026

(54) AUTOMATION SUPPORT DEVICE AND AUTOMATION SUPPORT METHOD

(71) Applicant: PANASONIC INTELLECTUAL PROPERTY MANAGEMENT CO., LTD., Osaka (JP)

(72) Inventors: Suguru NAKAO, Hyogo (JP); Yusuke HASHIMOTO, Osaka (JP)

(73) Assignee: PANASONIC INTELLECTUAL PROPERTY MANAGEMENT CO., LTD., Osaka (JP)

(21) Appl. No.: 19/335,582

(22) Filed: Sep. 22, 2025

(30) Foreign Application Priority Data
Sep. 30, 2024 (JP) 2024-171430

(51) Int. Cl. B25J 9/16; G06Q 10/0639

(52) U.S. Cl. CPC B25J 9/163; G06Q 10/0639

(57) ABSTRACT

An automation support device supporting automation of a process included in work includes a processor. The processor acquires work procedure information regarding a process for a person to work and requirement specification information regarding a specification required for an automation system including a robot device that executes the process; determines a first configuration of the automation system based on the work procedure information; evaluates performance, productivity, and a cost of the automation system of the first configuration based on the work procedure information and the requirement specification information; and outputs first change support information for supporting a change in the first configuration of the automation system based on a result of the evaluation.

### TECHNICAL FIELD

The present disclosure relates to an automation support device and an automation support method.

### BACKGROUND ART

In the related art, an information processing device that supports editing of a work plan is known. The information processing device includes a calculation unit that calculates, when an assignment destination of one work assigned to a person is changed to one arm of a robot from a state where work is assigned to each arm of the robot having a plurality of arms and the person, a work time of the person after the change and a work time of the robot, a comparison unit that compares the work time calculated by the calculation unit with the work time of the robot, and a warning unit that issues a warning when the work time of the robot is longer than the work time of the person as a result of the comparison by the comparison unit (see Patent Literature 1).

### CITATION LIST

### Patent Literature

Patent Literature 1: JP6935772B

### SUMMARY OF INVENTION

### Technical Problem

The present disclosure provides an automation support device and an automation support method capable of suitably automating a process in consideration of the entire work by a robot device.

### Solution to Problem

One aspect of the present disclosure is an automation support device supporting automation of a process included in work, and includes a processor. The processor is configured to acquire work procedure information regarding a process for a person to work and requirement specification information regarding a specification required for an automation system including a robot device that executes the process; determine a first configuration of the automation system based on the work procedure information; evaluate performance, productivity, and a cost of the automation system of the first configuration based on the work procedure information and the requirement specification information; and output first change support information for supporting a change in the first configuration of the automation system based on a result of the evaluation.

Another aspect of the present disclosure is an automation support method for supporting automation of a process included in work. The automation support method includes acquiring work procedure information regarding a process for a person to work and requirement specification information regarding a specification required for an automation system including a robot device that executes the process; determining a first configuration of the automation system based on the work procedure information; evaluating performance, productivity, and a cost of the automation system of the first configuration based on the work procedure information and the requirement specification information; and outputting first change support information for supporting a change in the first configuration of the automation system based on a result of the evaluation.

### Advantageous Effects of Invention

According to the present disclosure, the process can be suitably automated in consideration of the entire work by the robot device.

### BRIEF DESCRIPTION OF DRAWINGS

FIG. 1 is a block diagram showing a configuration example of an automation support device;

FIG. 2 is a block diagram showing an example of various databases included in a memory;

FIG. 3 is a block diagram showing an example of various processes executed by a processor;

FIG. 4 is a flowchart showing an operation example of the automation support device;

FIG. 5 shows an example of an initial automation configuration;

FIG. 6 shows a specific example of each countermeasure method and a degree of influence thereof when an evaluation result is NG;

FIG. 7 shows a state of container packing work of articles by a person;

FIG. 8 is an external perspective view showing an example of an automation system having the initial automation configuration;

FIG. 9 shows an example of a display according to evaluation of the initial automation configuration;

FIG. 10 is an external perspective view showing an example of the automation system having an automation configuration after a first change;

FIG. 11 shows an example of a display according to the evaluation of an automation configuration after the first change;

FIG. 12 is an external perspective view showing an example of the automation system having an automation configuration after a second change; and

FIG. 13 shows an example of a display according to the evaluation of an automation configuration after the second change.

### DESCRIPTION OF EMBODIMENTS

Hereinafter, embodiments will be described in detail with reference to the drawings as appropriate. However, the unnecessarily detailed description may be omitted. For example, the detailed description of well-known matters and the redundant description of substantially the same configuration may be omitted. This is to avoid unnecessary redundancy in the following description and to facilitate understanding of those skilled in the art. The accompanying drawings and the following description are provided for those skilled in the art to fully understand the present disclosure, and are not intended to limit the scope of the claims.

### Circumstances Leading to Obtaining an Embodiment According to Present Disclosure

In the information processing device of Patent Literature 1, the comparison of the work time between the robot and the person is mainly performed, and the determination of whether automation including factors other than the work time, for example, a cost required for the work and the ability of the robot that performs the work is possible is not performed. In order to automate the work performed by a person, many parameters are required, but only one of the parameters is taken into consideration in the information processing device of Patent Literature 1. Therefore, even if the work time of the robot is selected to be short, the cost required for the work of the robot is high or the work accuracy of the robot is low, and it is difficult to perform automation in consideration of the entire work of the robot device.

In the following embodiments, an automation support device and an automation support method capable of suitably automating a process in consideration of the entire work by a robot device will be described.

### First Embodiment

### Configuration of Automation Support Device

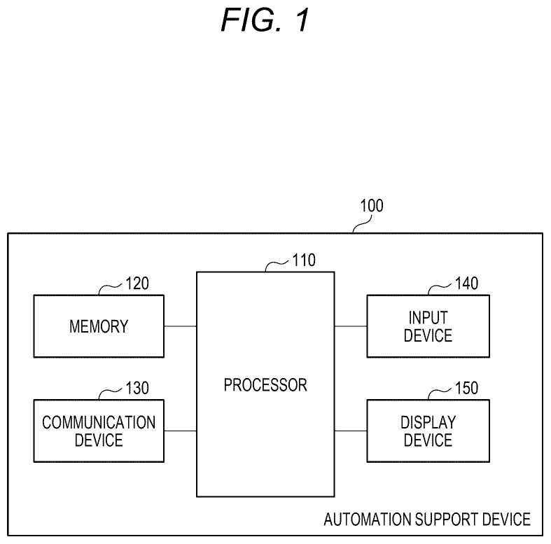

FIG. 1 is a block diagram showing a configuration example of an automation support device. An automation support device 100 includes a processor 110, a memory 120, a communication device 130, an input device 140, and a display device 150. The automation support device 100 supports derivation of an automation system that executes each process (for example, a manufacturing process) included in work.

The processor 110 may be implemented using, for example, a central processing unit (CPU), a digital signal processor (DSP), or a graphics processing unit (GPU). The processor 110 may be implemented using various integrated circuits (for example, a large scale integration (LSI) or a field programmable gate array (FPGA)). The processor 110 implements various functions by executing a program stored in the memory 120. The processor 110 integrally controls units of the automation support device 100 and executes various processes.

The memory 120 may include a random access memory (RAM), a read only memory (ROM), a hard disk drive (HDD), a solid state drive (SSD), an optical disk, an SD card, or the like. The memory 120 may be an external storage medium or may be detachable from the automation support device 100. The memory 120 stores various types of data, information, programs, learning models, or the like.

The communication device 130 communicates various types of data or information in accordance with a wired or wireless communication method. The communication method by the communication device 130 may include a Local Area Network (LAN), a Wide Area Network (WAN), a cellular phone network, or a communication system such as power line communication.

The input device 140 may include various buttons, keys, a keyboard, a touch panel, a microphone, a sensor, a scanner, or other input devices. The input device 140 receives input of various types of data or information. The input device 140 is operated by a user. The user is, for example, a worker or an administrator who automates processes of various operations.

The display device 150 is, for example, a liquid crystal display or an organic EL display. The display device 150 displays various types of data or information. The display by the display device 150 may be confirmed by the user, for example.

Although the automation support device 100 has been described as having each component and each function in one device, the present disclosure is not limited thereto. For example, each component or each function of the automation support device 100 may be arranged in a distributed manner to form a system (automation support system). The system may be implemented by a cloud type on a network or may be implemented by an on-premise type server device.

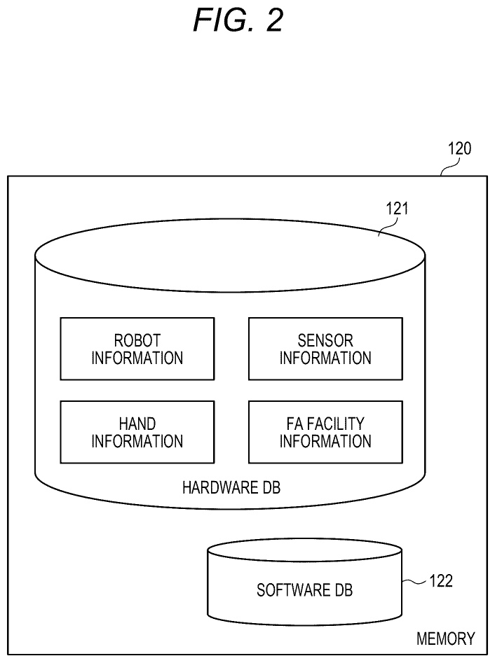

FIG. 2 is a block diagram showing an example of various databases included in the memory 120.

The memory 120 includes a hardware database 121 (also referred to as a hardware DB) and a software database 122 (software DB).

The hardware database 121 holds information (hardware) related to hardware that can be included in the automation system. Hardware information includes robot information, sensor information, hand information, and factory automation (FA) facility information.

The robot information includes information on the robot device, for example, information on a configuration of the robot device. The robot device includes a robot arm and a robot hand. The robot hand is also referred to as an end effector when connected to a tip of the robot arm. The robot information may include, for example, structure information on a structure of the robot device, arm information on a robot arm, and information on an installable position of the robot device, or may include other information. The structure information may include information indicating a type of structure of the robot device (for example, an orthogonal robot, a vertical articulated robot, or a type of other structure). The arm information may include information such as a shape, size, weight, and movable range of the robot arm.

The sensor information includes information on a sensor capable of detecting various events. The sensor may include a camera. Therefore, the sensor information may include an image captured by the camera. The sensor information includes information such as an event that can be detected by a type of a sensor (for example, a position detection sensor or a speed sensor) or a place where the sensor can be installed.

The hand information is information on a robot hand. The hand information may include, for example, information such as a type of a hand (for example, suction, two fingers, multiple fingers, types of other hands), a shape, a size, a weight, a feature of an article that can be gripped by a hand (for example, a gripping surface of an article is a flat surface, a gripping surface of an article is smooth, and an article is a predetermined weight or less) for each hand. That is, the hand information may include information indicating what can be grasped according to the type of the robot hand.

The factory automation (FA) facility information includes information on facilities necessary for automation in a factory (FA). The FA facility information includes, for example, conveyor information on a belt conveyor (for example, a type, shape, size, and weight of the belt conveyor), stand information on a stand (for example, a type, shape, size, and weight of the stand), container information on a container (for example, a type, shape, size, and weight of the container), and may include other information.

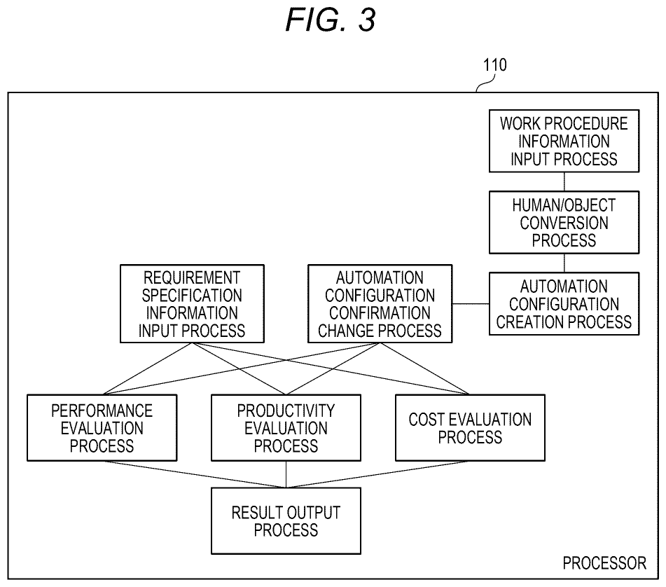

FIG. 3 is a block diagram showing an example of various processes executed by the processor 110.

The processor 110 executes a work procedure information input process, an automation configuration creation process, an automation configuration change process, a requirement specification information input process, a cost evaluation process, a productivity evaluation process, a performance evaluation process, and an evaluation result output process. The processor 110 may execute other processes.

The work procedure information input process is a process of inputting work procedure information. The work procedure information is information indicating the order of processes included in various types of work (for example, work in a factory), and is information on time-series processes for a person to work. The work procedure information is indicated in a form of a work procedure manual, for example. The work procedure manual may include at least information on the process content, and may not include time-series information.

The automation configuration creation process is a process of creating a configuration (automation configuration) of an automation system including a robot device capable of realizing each process of work based on each process of the work procedure information. The automation system includes, for example, a robot device (for example, a picking robot) that performs at least some processes of human work, and may include other peripheral devices (for example, a sensor, a camera, a PC, a belt conveyor, a container, a stand, and other devices or apparatuses).

The automation configuration confirmation and change process includes a process of confirming (recognizing or analyzing) the detailed configuration of the created or changed automation configuration. The automation configuration confirmation change process includes a process of changing the automation configuration and creating a new automation configuration. At this time, the processor 110 may receive a user input via the input device 14 with respect to an initial automation configuration or the changed automation configuration, and perform a minor change or fine adjustment of at least a part of the configuration in the automation configuration.

The requirement specification information input process is a process of inputting requirement specification information. The requirement specification information is information indicating a specification required for the automation system that executes each process included in the work. The requirement specification information includes, for example, information on specifications (requirement specifications) in various viewpoints required for introduction of the created automation system. For example, the requirement specification information includes information on a performance requirement specification related to performance (also referred to as capability or specification) of the automation system as to whether the capability of a robot is satisfied when replacing a person with the robot. In addition, the requirement specification information includes information on a productivity requirement specification related to productivity of the automation system. The productivity relates to a work time, and may be indicated by, for example, a cycle time. The requirement specification information includes information on a cost requirement specification related to a cost of the automation system.

The requirement specification information includes, for example, information (article) on an article (target object, workpiece) to be worked, facility information on a facility used for the work, operation information on an operation for performing the work, and cost information on the cost required for the work.

The article information may include information such as a size, weight, and material of an article to be worked. The facility information may include information such as a size of a container for unloading in which articles used at the time of placing are stored, a method of storing (packing) articles in the container for unloading, the number of articles to be stored in the container for unloading, or a specification, a speed, and a layout of a belt conveyor. The facility information may include information on a requirement specification related to a storage container in which an article used at the time of picking is stored.

The operation information may include information such as the required accuracy, the maximum number of repetitions, a cycle time, a production quantity of pick-and-place by the automation system, and an operating time and the number of days of the automation system. The maximum number of repetitions is an example of an index indicating the durability of the automation system. The cycle time may be calculated based on, for example, a production quantity and a production time required for producing one article.

The cost information may include information such as a labor cost when a person works, a depreciation cost of a robot device, or a labor cost rate. The above-described information included in the requirement specification information is an example, and the present disclosure is not limited thereto.

The cost evaluation process is a process of evaluating the cost required for the automation system. As an example, in the cost evaluation process, the processor 110 calculates a cost based on the hardware information or the software information held in the memory 120 and the assumed automation configuration information. The processor 110 evaluates the cost of the automation system by comparing the calculated cost with the cost information included in the requirement specification information. The evaluation of the cost here may be, for example, whether a total cost required to construct the automation system is within a predetermined cost.

The productivity evaluation process is a process of evaluating productivity by the automation system. As an example, in the productivity evaluation process, the processor 110 calculates the productivity (for example, a cycle time) based on the hardware information or the software information held in the memory 120 and the assumed automation configuration information. The processor 110 evaluates the productivity by comparing the calculated productivity with the operation information (for example, cycle time) included in the requirement specification information. The evaluation of the productivity here may be, for example, whether the cycle time of the pick-and-place of an article to be worked is within a predetermined time.

The performance evaluation process is a process of evaluating the performance of the automation system. As an example, in the performance evaluation process, the processor 110 calculates the performance based on the hardware information or the software information held in the memory 120 and the assumed automation configuration information. The processor 110 evaluates the performance by comparing the calculated performance with the article information and the facility information included in the requirement specification information. The evaluation of the performance here may be, for example, whether the pick-and-place of the article to be worked is possible.

The evaluation result output process is a process of outputting the evaluation result obtained by each evaluation process described above. The evaluation result includes, for example, a performance evaluation result, a productivity evaluation result, and a cost evaluation result, and may include other information. The processor 110 may output information on a countermeasure method for improving the evaluation and other information together with the evaluation result. The output may be other than display, and may include sound output, printing, and the like.

### Operation of Automation Support Device

Next, an operation of the automation support device 100 will be described.

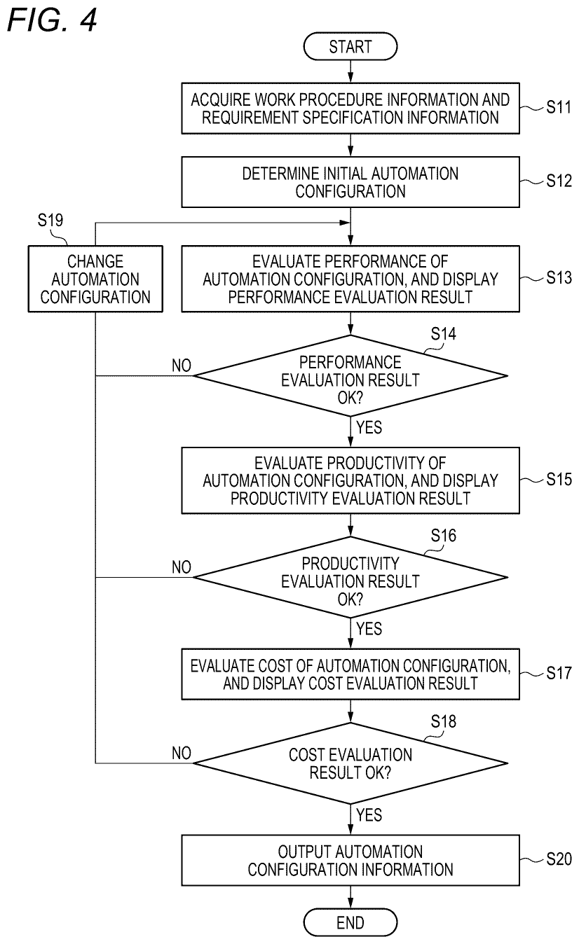

FIG. 4 is a flowchart showing an operation example of the automation support device 100. In the description of FIG. 4, as an example using the automation support device 100, an automation examination of work of packing an article completed in a production line of a factory into a container for unloading is exemplified.

The processor 110 acquires (inputs) the work procedure information and the requirement specification information (step S11). The work procedure information and the requirement specification information may be held in the memory 120 and acquired from the memory 120, may be received and acquired via the communication device 130, or may be acquired via the input device 140.

In step S11, the work procedure information may include, for example, the content of a work procedure manual or a work manual when the worker packs the article sent by the belt conveyor into the container. The work procedure information may include basic information of an article to be worked or a facility used to execute work.

The processor 110 determines an initial automation configuration based on the work procedure information (step S12). That is, the processor 110 creates a configuration of the initial automation system. Details of the initial automation configuration will be described later. The determination of the initial automation configuration is an example of the assumption of the automation configuration. After the process of step S12, the processor 110 may receive a user input via the input device 14 with respect to the created automation configuration, and perform a minor change or fine adjustment of at least a part of the configuration in the automation configuration.

The processor 110 evaluates the performance of the determined (assumed) automation configuration based on the requirement specification information (for example, performance requirement specification), and displays the performance evaluation result on the display device 15 (step S13). In this case, the processor 110 evaluates whether the performance of the assumed automation configuration (for example, initial automation configuration) with respect to the requirement specification information is satisfied, and obtains a performance evaluation result. The performance of the assumed automation configuration is the performance when the automation system is the configuration, in other words, the same as the performance of the automation system of the assumed configuration.

As an example, the performance evaluation result may include an evaluation result OK indicating that the performance of the automation configuration satisfies the requirement specification when the performance is satisfied with respect to the requirement specification information. As an example, the performance evaluation result may include an evaluation result NG indicating that the performance of the automation configuration does not satisfy the requirement specification when the performance is not satisfied with respect to the requirement specification information.

In the performance evaluation, for example, the processor 110 evaluates the positioning accuracy of the selected (assumed) robot device, a transportable weight carried by the robot device, a movement range of the robot arm, a picking area for picking by the robot device, the durability of the robot device, the degree of freedom of an arm for gripping an article by the robot device, a type of a gripper, the suitability of the gripper for the article, the necessity of image processing using a camera for position detection, the necessity of a positioning sensor, and the like. The movement range of the arm may be determined according to, for example, information on a range of a length or angle of the robot arm included in the requirement specification information. The degree of freedom of the arm for gripping the article varies depending on, for example, whether it is sufficient to move the robot hand from above with respect to the article or whether an operation of rotating the robot hand is necessary. The suitability of the gripper may be determined based on, for example, information on a width of a smooth surface of the article included in the requirement specification information.

The processor 110 determines whether the performance evaluation result satisfies the performance requirement specification (that is, the performance evaluation result is OK) (step S14).

When the performance evaluation result satisfies the performance requirement specification (Yes in step S14), the processor 110 evaluates the productivity of the automation configuration and displays the productivity evaluation result on the display device 15 (step S15). In this case, the processor 110 evaluates whether the productivity of the assumed automation configuration (for example, initial automation configuration) with respect to the requirement specification information is satisfied, and obtains a productivity evaluation result. The productivity of the assumed automation configuration is the productivity when the automation system is the configuration, in other words, the same as the productivity of the automation system of the assumed configuration.

As an example, the productivity evaluation result may include an evaluation result OK indicating that the productivity of the automation configuration satisfies the requirement specification when the productivity is satisfied with respect to the requirement specification information. As an example, the productivity evaluation result may include an evaluation result NG indicating that the productivity of the automation configuration does not satisfy the requirement specification when the productivity is not satisfied with respect to the requirement specification information.

In the evaluation of the productivity, for example, the processor 110 calculates a movement time of the robot arm, an operation time of the robot hand, and the like to calculate the cycle time on the assumption that the robot arm operates at a predetermined speed or acceleration and the robot hand operates at a predetermined speed or acceleration in the assumed automation configuration. The processor 110 may compare a cycle time by the human work with a cycle time by the automation configuration. The processor 110 may compare the production quantity per day or month by the human work with the production quantity per day or month by the automation configuration.

The processor 110 determines whether the productivity evaluation result satisfies the productivity requirement specification (that is, the productivity evaluation result is OK) (step S16).

When the productivity evaluation result satisfies the productivity requirement specification (Yes in step S16), the processor 110 evaluates the cost of the automation configuration and displays the cost evaluation result on the display device 15 (step S17). In this case, the processor 110 evaluates whether the cost of the assumed automation configuration (for example, initial automation configuration) with respect to the requirement specification information is satisfied, and obtains a cost evaluation result. The cost of the assumed automation configuration is a cost when the automation system is the configuration, in other words, the same as the cost of the automation system of the assumed configuration.

As an example, the cost evaluation result may include an evaluation result OK indicating that the cost of the automation configuration satisfies the requirement specification when the cost is satisfied with respect to the requirement specification information. As an example, the productivity evaluation result may include an evaluation result NG indicating that the cost of the automation configuration does not satisfy the requirement specification when the cost is not satisfied with respect to the requirement specification information.

In the cost evaluation, for example, the processor 110 may calculate a cost required for the automation configuration (automation cost) based on an initial investment cost, a running cost, and a depreciation period of the assumed automation configuration. The processor 110 may calculate an annual cost in the case of the human work based on a cost per unit time and the operation information in the case where the same work is performed by a person (in the case of the human work). The processor 110 compares the automation cost required in the case of the automation configuration with the annual cost required in the case of the human work. As a result of the comparison, when the automation cost in the case of the automation configuration is lower than the annual cost in the case of the human work, it may be determined that this automation configuration satisfies a cost requirement index.

The processor 110 determines whether the cost evaluation result satisfies the cost evaluation index (that is, the cost evaluation result is OK) (step S18).

On the other hand, when the performance evaluation result does not satisfy the performance requirement specification (No in step S14), when the productivity evaluation result does not satisfy the productivity requirement specification (No in step S16), or when the cost evaluation result does not satisfy the cost requirement specification (No in step S18), the processor 110 changes the assumed automation configuration (step S19). In this case, the processor 110 may receive an input from the user via the input device 140 and change the automation configuration. At this time, the user may check, for example, the information on the evaluation result or the information on the countermeasure method displayed on the display device 150 to refer to a change in automation configuration. Therefore, the automation support device 100 can provide information useful for determining the automation configuration. Therefore, the change, evaluation, and the like of the automation configuration may be repeated until each evaluation result for the automation configuration after the change satisfies each requirement specification.

For example, when the performance evaluation result does not satisfy the performance requirement specification (No in step S14), the processor 110 changes the automation configuration such that the performance can be improved by changing the robot device to a robot device having excellent performance, reducing the weight of the robot hand, or the like (step S19). After the process of step S19, the process proceeds to step S13.

In a case where there is no robot device or automation configuration compatible with the change described above, the processor 110 may change the requirement specification information to be robot friendly. Specifically, the processor 110 may change the layout configuration by reducing a distance between a picking position and a place position or reducing a picking area (for example, an area of the container for storage) or a place area (for example, an area of the container for unloading). Accordingly, cost reduction of the automation configuration can also be expected.

For example, when the productivity evaluation result does not satisfy the productivity requirement specification (No in step S16), the processor 110 changes the automation configuration such that the cycle time can be reduced by increasing an operation speed of the robot device, increasing the number of robot devices, performing a large number of processes by changing the specification of the robot hand, and the like (step S19). After the process of step S19, the process proceeds to step S13.

In a case where there is no robot device or automation configuration compatible with the change described above, the processor 110 may change the requirement specification information to be robot friendly. Specifically, the processor 110 may increase a movable time or the number of production days of the robot device. Accordingly, cost reduction of the automation configuration can also be expected.

When the cost evaluation result does not satisfy the cost requirement specification (No in step S18), as an example, the processor 110 changes the automation configuration so as to realize cost reduction of the automation configuration such as a change to an inexpensive robot device or reduction in peripheral devices (for example, a camera for image processing) (step S19). After the process of step S19, the process proceeds to step S13.

In a case where there is no robot device or automation configuration compatible with the change described above, the processor 110 may change the requirement specification information to be robot friendly. Specifically, the processor 110 may shorten the depreciation period. Accordingly, the cost reduction of the automation configuration can also be expected.

The countermeasure methods for improving the performance evaluation result, the productivity evaluation result, and the cost evaluation result have different correlations with the three requirement specifications (performance requirement specification, productivity requirement specification, and cost requirement specification). Therefore, even if the evaluation result is improved for one requirement specification, the evaluation result may be deteriorated for another requirement index. Therefore, the processor 110 returns to step S13 and performs the three evaluations (performance evaluation, productivity evaluation, and cost evaluation) again on the automation configuration after the change.

When the cost evaluation result satisfies the cost requirement specification (Yes in step S18), that is, when each of the three evaluation results satisfies each requirement specification, the processor 110 determines the automation configuration as the assumed automation configuration, and outputs information on the determined automation configuration (also referred to as automation configuration information) (step S20). The automation configuration information includes, for example, information on hardware and software included in the automation system having the determined configuration, and may include identification information of apparatuses or devices, a connection relationship of apparatuses or devices, installation information of software, and the like. The output here includes, for example, transmission to an external device via the communication device 130, holding of information in the memory 120, or display via the display device 150, and may include output by another method.

For example, the user can recognize the configuration of the automation system corresponding to the automation configuration information by confirming the display of the automation configuration information, and can install or set various types of hardware (for example, various types of apparatuses, devices, and sensors), software (for example, an OS and an API), and the like included in the automation system.

As described above, the automation support device 100 compares the requirement specification information and the automation configuration with respect to the initial automation configuration from three viewpoints of “performance”, “productivity”, and “cost”. The automation support device 100 can derive a final automation configuration and a final operation scenario that satisfy the three viewpoints.

The operation scenario indicates, for example, a procedure (scenario) of an operation for executing each process by the determined automation configuration. For example, it is assumed that an automation system including a robot hand capable of picking and placing two articles at the same time is finally determined. In this case, since it is not assumed that two articles can be picked and placed at the same time in the work procedure manual, “two articles are picked and placed”, but in the operation scenario, since two articles can be picked and placed at the same time, “two articles are picked and placed at the same time”. For example, the processor 110 may generate the operation scenario based on the determined automation configuration and the work procedure manual.

Although the information including the evaluation results is output at different timings in step S13, step S15, and step S17, the present disclosure is not limited thereto. Information including the evaluation results may be output at the same timing at any timing after step S17 after each evaluation is completed.

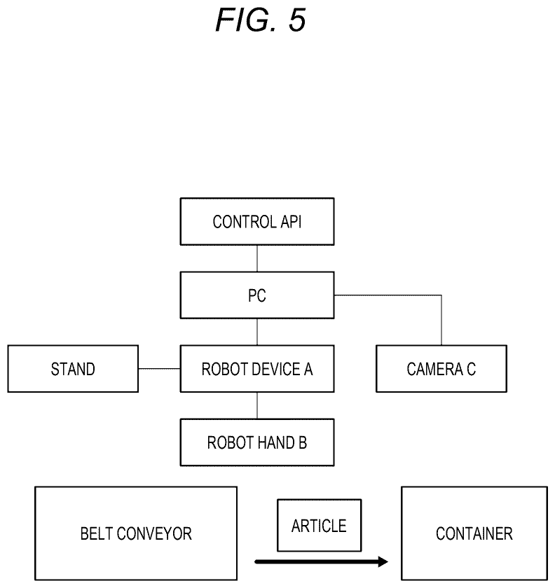

FIG. 5 shows an example of an initial automation configuration.

The memory 120 holds, for example, information (also referred to as standard configuration information) regarding a standard configuration for performing each step. This standard configuration is a base configuration of the automation configuration. The processor 110 acquires the automation configuration by determining the automation configuration capable of executing each process included in the work procedure information based on the standard configuration information. The standard configuration information may be accumulated in an external device (for example, an external server) instead of the memory 120. In this case, the processor 110 may acquire the standard configuration information from the external device via the communication device 130.

For example, an initial automation configuration for performing each step of the packing work of articles includes a control application programming interface (API), a personal computer (PC), a stand, a robot device A, a robot hand B, a camera C, a belt conveyor, and a container. For example, the robot device can be formed by at least one of a plurality of structures, and here, the processor 110 designates the robot device A (for example, an articulated robot). For example, the robot hand B can be formed by at least one of a plurality of hand types, and here, the processor 110 designates the robot hand B (for example, a suction type). For example, the processor 110 may designate whether another component (for example, a PC) is included in the initial automation configuration or designate at least one of a plurality of options.

The initial automation configuration may be changed in consideration of requirement specification information that cannot be grasped in the work procedure information. For example, the initial automation configuration may be changed in a case where an actual article to be worked cannot be gripped in consideration of the weight, the size, and the like of the article or in a case where the reach of the robot arm is insufficient at the time of pick-and-place.

After the initial automation configuration is determined, the automation configuration is sequentially updated so that the performance, productivity, and cost of the automation configuration satisfy the requirement specification information of each process.

### Specific Example of Countermeasure Method in Case of Evaluation Result NG

Next, each countermeasure method and a degree of influence thereof when the evaluation result is NG will be described.

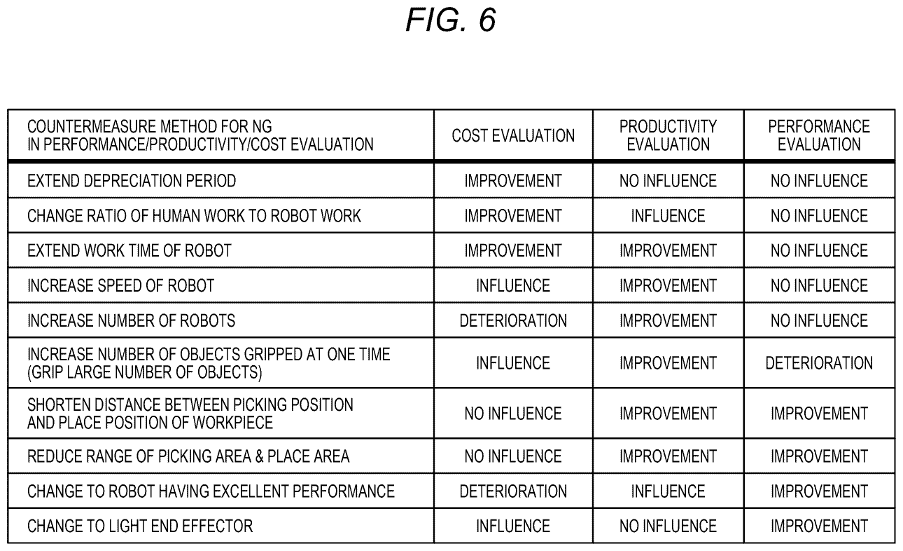

FIG. 6 shows a specific example of each countermeasure method and a degree of influence thereof when an evaluation result is NG. In FIG. 6, for each countermeasure method, prediction information of cost evaluation, prediction information of productivity evaluation, and prediction information of performance evaluation are associated and held. The information in FIG. 6 may be held in the memory 120 or may be acquired from the external device via the communication device 130. In FIG. 6, the robot device is also simply referred to as a robot, and the article to be worked is also simply referred to as a workpiece. The countermeasure methods and the prediction information of each evaluation may be output to the processor 110 (for example, displayed via the display device 150), and may be used to change the automation configuration or change the requirement specification information.

The prediction information of the cost evaluation is information indicating a degree of improvement (degree of influence) of a cost required for the automation configuration after the change with respect to a cost required for the automation configuration before the change in a case where the countermeasure method is performed and the automation configuration is changed. The prediction information of the productivity evaluation is information indicating a degree of improvement (degree of influence) of the productivity of the automation configuration after the change with respect to the productivity of the automation configuration before the change in a case where the countermeasure method is performed and the automation configuration is changed. The prediction information of the performance evaluation is information indicating a degree of improvement (degree of influence) of the performance of the automation configuration after the change with respect to the performance of the automation configuration before the change in a case where the countermeasure method is performed and the automation configuration is changed.

The countermeasure method includes, for example, “extending a depreciation period”, “changing a ratio between human work and robot work”, “extending a work time of a robot (robot device)”, “increasing a speed of a robot”, “increasing the number of robots”, “increasing the number of objects gripped at one time (gripping a large number of objects)”, “reducing a distance between a picking position and a place position of a workpiece (article)”, “reducing a range of a picking area & place area”, “changing to a robot having excellent performance”, and “changing to an end effector having a light weight”, and may include other countermeasure methods. The prediction information of the cost evaluation, the prediction information of the productivity evaluation, and the prediction information of the performance evaluation may be indicated by, for example, “improvement”, “deterioration”, and “no influence”, or may be indicated by other information.

In the case of the countermeasure method of increasing a speed of the robot device, the relationship may be such that the specifications of the automation system increase and the cost of the automation system increases. That is, the relationship may be different from that in FIG. 6.

Among the countermeasure methods in FIG. 6, “increasing a speed of a robot”, “increasing the number of robots”, “increasing the number of objects gripped at one time (gripping a large number of objects)”, “changing to a robot having excellent performance”, “changing to an end effector having a light weight”, and the like are examples of a countermeasure method for changing the automation configuration. Among the countermeasure methods in FIG. 6, “extending a depreciation period”, “changing a ratio between human work and robot work”, “extending a work time of a robot (robot device)”, “reducing a range of picking area & place area”, and the like are examples of a change in the requirement specification information.

One countermeasure method may be a trade-off for each evaluation result. That is, one evaluation result is improved by performing one countermeasure method, but other evaluation results may be deteriorated. In this case as well, the automation support device 100 can prevent the entire work from becoming inappropriate by re-evaluating a new automation configuration.

The information shown in FIG. 6 can be used, for example, as follows.

When the processor 110 of the automation support device 100 performs the process in accordance with the flowchart of FIG. 4, the automation configuration is changed by automatically changing a parameter related to the automation configuration by the process of step S19, and thus it is not necessary to display the information in FIG. 6 on a screen of the display device 150. On the other hand, when at least one item of the cost evaluation, the productivity evaluation, and the performance evaluation is not evaluated as OK, the processes of steps S13 to S19 in FIG. 4 are repeated.

On the other hand, when the processes in steps S13 to S19 in FIG. 4 loop a certain number of times and at least one item is not evaluated as OK, the processor 110 may display the information in FIG. 6 on the screen and cause the user to select one of the countermeasure methods via the input device 140. The processor 110 may display the information in FIG. 6 and cause the user to select any one of the countermeasure methods via the input device 140 every time any one of the cost evaluation, the productivity evaluation, and the performance evaluation is evaluated as NG.

When the processor 110 performs the process in accordance with the flowchart of FIG. 4, if only the first performance evaluation is performed and the evaluation is NG, the productivity evaluation and the cost evaluation are not performed, and the results of the productivity evaluation and the cost evaluation are not obtained. Therefore, the processor 110 may output the evaluation result such as evaluation OK or evaluation NG after all of the three evaluations (cost evaluation, productivity evaluation, and performance evaluation) are obtained. That is, in this case, the processor 110 may perform the processes in the order of step S13, step S15, step S17, step S14, step S16, and step S18.

### Use Case

Next, a use case of automation support by the automation support device 100 will be described.

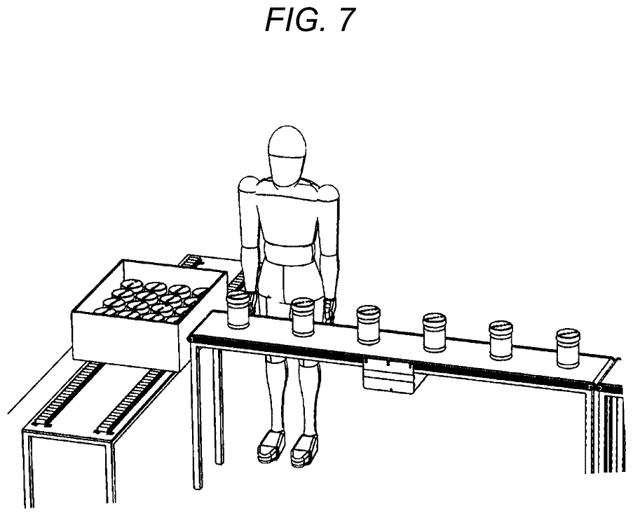

FIG. 7 shows a state of container packing work of articles by a person (worker). The automation support device 100 automates each process so that each process of such container packing work of articles is executed by the automation system.

The processor 110 assumes an automation configuration by creating an initial automation configuration or the like. The processor 110 derives each evaluation result (for example, the productivity evaluation result, the cost evaluation result, and the performance evaluation result) based on the assumed automation configuration. The processor 110 refers to the memory 120 and derives a countermeasure method for improving the evaluation and a degree of influence (improvement degree) of the countermeasure method based on each evaluation result. Here, the processor 110 can recognize which index is improved by selecting which countermeasure method. Therefore, the processor 110 can increase the possibility that the evaluation result is improved by selecting a countermeasure method for improving the viewpoint (for example, performance, productivity, and cost) of the evaluation result NG. The processor 110 presents (for example, displays) information on each evaluation result, each countermeasure method, and the degree of influence of each countermeasure method.

For example, the user confirms information on each evaluation result, each countermeasure method, and the degree of influence of each countermeasure method displayed on the display device 150. The user performs at least one countermeasure among the countermeasure methods in consideration of the degree of influence of each countermeasure method, that is, changes at least a part of the configuration in the automation configuration. The processor 110 receives a user input via, for example, the input device 140 and obtains information on the automation configuration in which the changed configuration is reflected.

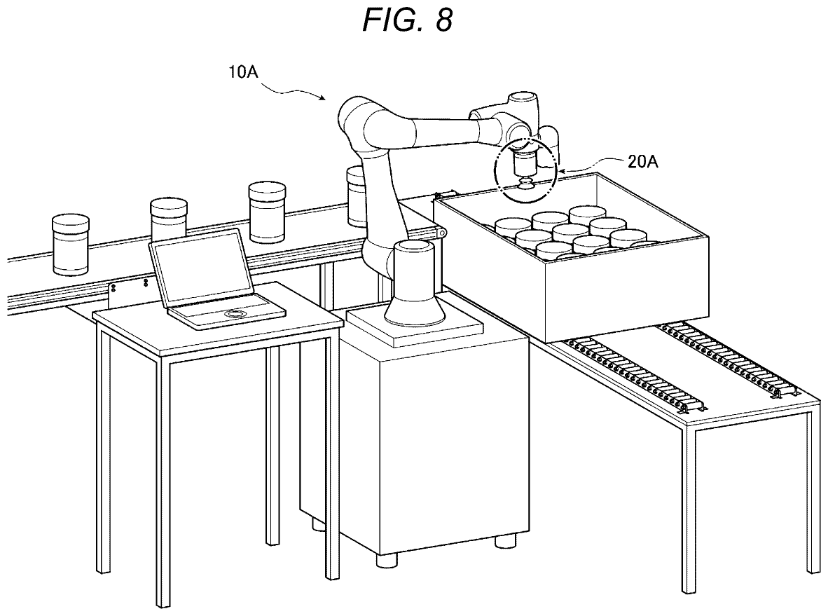

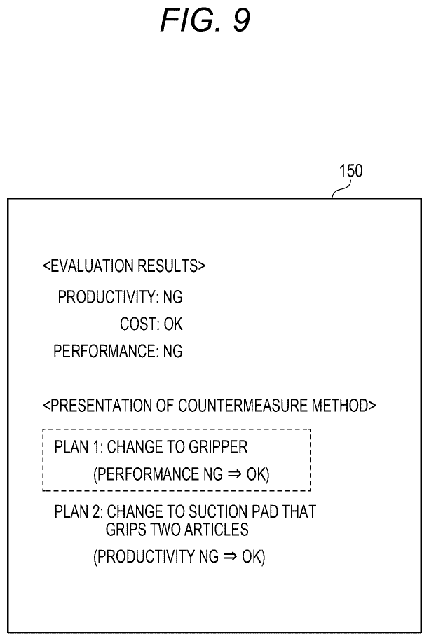

FIG. 8 is an external perspective view showing an example of an automation system 10A having the initial automation configuration. FIG. 9 shows an example of a display according to evaluation of the initial automation configuration. The initial automation configuration shown in FIG. 8 has a configuration shown in FIG. 5 as an example.

First, it is assumed that the initial automation configuration includes a robot hand 20A whose hand type is a suction type. In this case, as an example of the evaluation result, the productivity evaluation result is NG, the cost evaluation result is OK, and the performance evaluation result is NG. The countermeasure method includes, as an example, Plan 1 of changing to a gripper that grips an article and Plan 2 of changing to a suction pad that can simultaneously grip two articles. In Plan 1, the performance NG becomes the performance OK, and the performance is improved. In Plan 2, the productivity NG becomes the productivity OK, and the productivity is improved. In FIG. 9, as an example, Plan 1 is selected by the user via the input device 14 and reflected in the change in automation configuration. A broken-line frame in FIG. 9 indicates that Plan 1 is selected. In Plan 1, for example, the robot hand can easily hold a bottle with a cap. The information displayed on the display device 150 shown in FIG. 9 is information for supporting a change in the automation configuration, and is an example of first change support information.

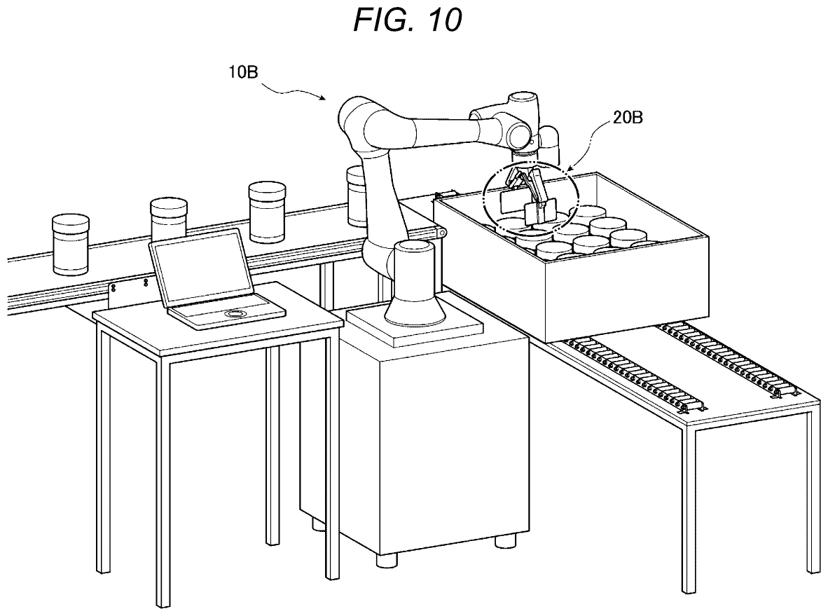

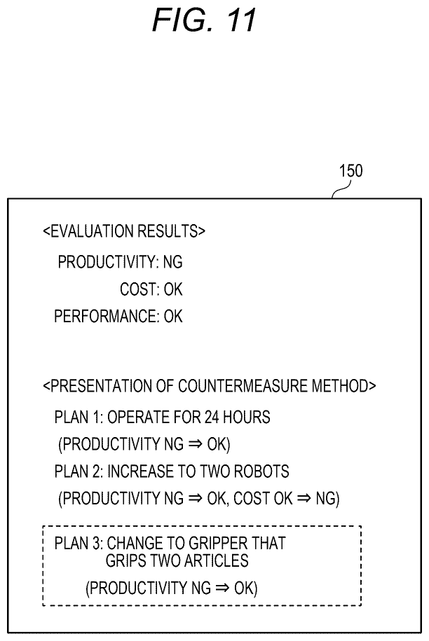

FIG. 10 is an external perspective view showing an example of an automation system 10B having an automation configuration after a first change. FIG. 11 shows an example of a display according to the evaluation of an automation configuration after the first change.

The automation configuration after the first change includes, as described above, a robot hand 20B whose hand type is a gripper for taking one robot hand. In this case, as an example of the evaluation result, the productivity evaluation result is NG, the cost evaluation result is OK, and the performance evaluation result is OK. The countermeasure method includes, as an example, Plan 1 for operating the automation system for 24 hours, Plan 2 for increasing the number of robot devices to two, and Plan 3 for changing to a gripper capable of simultaneously gripping two robot hands. Operating the automation system for 24 hours is an example of extension of the work time of the robot device. In Plan 1, the productivity NG becomes the productivity OK, and the productivity is improved. In Plan 2, the productivity NG becomes the productivity OK, and the productivity is improved, whereas the cost OK becomes the cost NG, and the cost is reduced. In Plan 3, the productivity NG becomes the productivity OK, and the productivity is improved. In FIG. 11, as an example, Plan 3 is selected by the user and reflected in the change in automation configuration. A broken-line frame in FIG. 11 indicates that Plan 3 is selected. The information displayed on the display device 150 shown in FIG. 11 is an example of output information including evaluation information. Operating the automation system for 24 hours is information for supporting the change in requirement specification information, and is an example of second change support information.

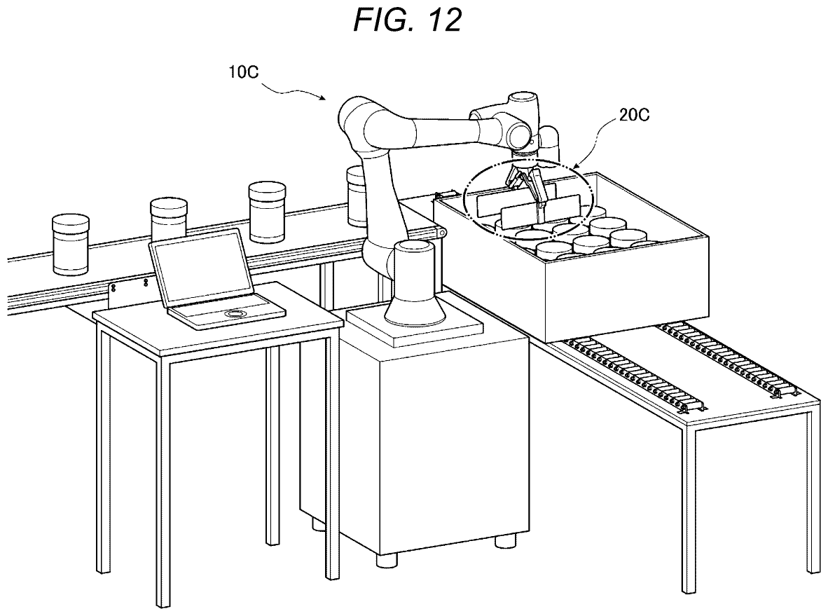

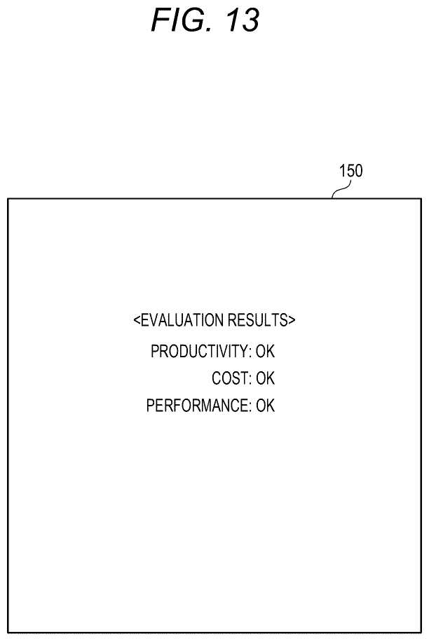

FIG. 12 is an external perspective view showing an example of an automation system 10C having an automation configuration after a second change. FIG. 13 shows an example of a display according to the evaluation of an automation configuration after the second change.

As described above, the automation configuration after the second change includes a robot hand 20C, which is a gripper capable of gripping two hand types at the same time. In this case, as an example of the evaluation result, the productivity evaluation result is OK, the cost evaluation result is OK, and the performance evaluation result is OK. That is, the productivity evaluation result, the cost evaluation result, and the performance evaluation result are all OK. When the productivity evaluation result, the cost evaluation result, and the performance evaluation result are all OK, the processor 110 determines the automation configuration to be adopted as the automation configuration (automation configuration FIX). In the display according to the evaluation after the second change shown in FIG. 13, the countermeasure method may not be displayed.

In the examples shown in FIGS. 8 to 13, the automation support device 100 can improve a gripping success rate of an article by changing the robot hand from the suction type to a gripper that can be gripped. That is, the performance of the automation system can be improved. Further, the automation support device 100 can reduce an increase in cost and reduce the cycle time to half by changing a gripper capable of simultaneously gripping one article to a gripper capable of simultaneously gripping two articles. That is, the productivity of the automation system can be improved and the cost can be reduced. In this way, the automation support device 100 can satisfy the requirement specifications from three viewpoints.

As a display example, the breakdown of each evaluation result may be displayed in detail. For example, the cost due to the human work and the cost in the case of the automation configuration may be displayed, and the breakdown of the cost in the case of the human work (for example, the man-hours, a rate related to the cost, and the work time) and the breakdown of the cost in the case of the robot device (for example, the man-hours, the rate related to the cost, and the work time) may be displayed. Accordingly, the user can confirm a cost difference between the human work and the work by the robot device by confirming the display, and can intuitively understand the advantage of introducing the automation system.

As described above, the automation support device 100 according to the present embodiment can evaluate the automation system not only from a single viewpoint but also from various viewpoints with respect to the configuration of the created automation system. Therefore, the automation support device 100 can suitably automate the process in consideration of the entire work by the automation system including the robot device. For example, when the work time of the robot device is selected to be shortened, the cost required for the work of the robot device can also be reduced, and a decrease in work accuracy can also be prevented. Therefore, the automation support device 100 can easily derive an automation system that is highly evaluated from each viewpoint even for a user unfamiliar with the automation system, and can reduce a threshold of introduction of the automation system.

Further, the automation support device 100 can generate an operation scenario for executing each process by the finally determined automation system, and provide a platform capable of easily executing each process according to the operation scenario. In this way, the automation support device 100 can easily determine the automation system from the viewpoints of both hardware and software even for the user unfamiliar with the automation system.

In the present embodiment, the automation support device 100 may determine whether it is better to perform automation by an automation system or to perform human work. When automation is difficult, the automation support device 100 may determine to perform human work. For example, the automation support device 100 may change the automation configuration when the process does not satisfy a predetermined requirement specification. The automation support device 100 may change the requirement specification when the automation configuration cannot be changed or when the requirement specification is not satisfied even if the automation configuration is changed. Further, when the requirement specification cannot be changed, the automation support device 100 may determine that automation is difficult, determine to perform the process to be automated by a person, and cause the display device 150 to display the determination result.

In the present embodiment, the automation support device 100 mainly supports the automation of a process of work in a factory, but the present disclosure is not limited thereto, and the automation support device 100 may be applied to support a process of work in other situations. For example, the automation support device 100 may support automation of a process of work related to logistics.

### Overview of Embodiment

As described above, at least the following matters are described in the present disclosure. Components corresponding to those in the above embodiment are shown in parentheses, but the present disclosure is not limited thereto.

### Item 1

An automation support device (automation support device 100) including a processor (processor 110) and configured to support automation of a process included in work, in which
the processor is configured to:
acquire work procedure information regarding a process for a person to work and requirement specification information regarding a specification required for an automation system that executes the process;
determine a first configuration (initial automation configuration) of the automation system based on the work procedure information;
evaluate performance, productivity, and cost of the automation system of the first configuration based on the work procedure information and the requirement specification information; and
output first change support information for supporting a change in the first configuration of the automation system based on a result of the evaluation.

Accordingly, the automation support device can determine the configuration of the automation system that executes each process in consideration of not only one parameter such as a cycle time but also the entire work by the robot device in consideration of performance, productivity, and cost, that is, can automate each process. Further, a user who has confirmed the output of the first change support information can change a first configuration of the automation system and determine the automation system having a suitable configuration. The processor may display the first change support information via a display device (an example of an output device) as an example of the output of the first change support information.

### Item 2

The automation support device according to item 1, in which the processor is configured to:
evaluate performance, productivity, and a cost of the automation system of a second configuration (automation configuration after the change) in which the first configuration is changed, based on the work procedure information and the requirement specification information; and
output output-information including a result of the evaluation.

By changing the configuration of the automation system, the evaluation may be improved from one viewpoint, and the evaluation may be deteriorated from another viewpoint. On the other hand, the automation support device can avoid determining the configuration of the automation system with a low-evaluation configuration by performing the evaluation again on the automation system with the changed configuration.

### Item 3

The automation support device according to item 2, in which
when at least one of the performance, the productivity, and the cost of the automation system of the second configuration does not satisfy the requirement specification information, the processor outputs second change support information for supporting a change in the requirement specification information.

Accordingly, even when the automation support device cannot satisfy the requirement specification due to a change in the configuration of the automation system, it can be expected that each process can be automated by changing the requirement specification information. The processor may display the second change support information via a display device (an example of an output device) as an example of the output of the second change support information.

### Item 4

The automation support device according to any one of items 1 to 3, in which
the first change support information includes an evaluation result of the evaluation of the performance, the productivity, and the cost, and countermeasure information (information on a countermeasure method) regarding a countermeasure for improving the evaluation of the performance, the productivity, and the cost.

Accordingly, the user can easily grasp what kind of change should be specifically added to the configuration of the automation system by confirming the countermeasure information.

### Item 5

The automation support device according to item 4, in which
the countermeasure information includes content of the countermeasure and influence information (information on the degree of influence) regarding an influence of execution of the countermeasure on the evaluation of the performance, the productivity, and the cost.

Accordingly, by checking the countermeasure information, the user can easily grasp how the change in the configuration of the automation system due to the countermeasure affects the evaluation.

### Item 6

The automation support device according to any one of items 2 to 5, in which
when all of the performance, the productivity, and the cost of the automation system of the second configuration satisfy the requirement specification information, the processor generates an operation scenario for the automation system of the second configuration to execute each process based on the automation system of the second configuration and the work procedure information.

Accordingly, the automation support device can generate a detailed operation scenario in which each process can be executed by the automation system having a finally determined configuration, for example.

### Item 7)

An automation support method for supporting automation of a process included in work, the automation support method comprising:
acquiring work procedure information regarding a process for a person to work and requirement specification information regarding a specification required for an automation system including a robot device that executes the process;
determining a first configuration of the automation system based on the work procedure information;
evaluating performance, productivity, and a cost of the automation system of the first configuration based on the work procedure information and the requirement specification information; and
outputting first change support information for supporting a change in the first configuration of the automation system based on a result of the evaluation.

Thereby, the same effect as that of item 1 is obtained.

Although various embodiments are described above with reference to the drawings, it is needless to say that the present disclosure is not limited to such examples. It is apparent that those skilled in the art can conceive of various modifications or corrections within the scope described in the claims, and it is understood that such modifications or corrections naturally fall within the technical scope of the present disclosure. The components in the above embodiments may be freely combined without departing from the scope of the invention.

### INDUSTRIAL APPLICABILITY

The present disclosure is useful for an automation support device, an automation support method, and the like capable of suitably automating a process in consideration of the entire work by a robot device.

### REFERENCE SIGNS LIST

10A, 10B, 10B Automation system
20A, 20B, 20C Robot hand
100 Automation support device
110 Processor
120 Memory
121 Hardware database (hardware DB)
122 Software database (software DB).
130 Communication device
140 Input device
150 Display device

1. An automation support device supporting automation of a process included in work comprising:
a processor, wherein
the processor is configured to:
acquire work procedure information regarding a process for a person to work and requirement specification information regarding a specification required for an automation system including a robot device that executes the process;
determine a first configuration of the automation system based on the work procedure information;
evaluate performance, productivity, and a cost of the automation system of the first configuration based on the work procedure information and the requirement specification information; and
output first change support information for supporting a change in the first configuration of the automation system based on a result of the evaluation.

2. The automation support device according to claim 1, wherein
the processor is configured to:
evaluate performance, productivity, and a cost of the automation system of a second configuration in which the first configuration is changed, based on the work procedure information and the requirement specification information; and
output output-information including a result of the evaluation.

3. The automation support device according to claim 2, wherein
in a case that at least one of the performance, the productivity, and the cost of the automation system of the second configuration does not satisfy the requirement specification information, the processor outputs second change support information for supporting a change in the requirement specification information.

4. The automation support device according to claim 1, wherein
the first change support information includes an evaluation result of the evaluation of the performance, the productivity, and the cost, and countermeasure information regarding a countermeasure for improving the evaluation of the performance, the productivity, and the cost.

5. The automation support device according to claim 4, wherein
the countermeasure information includes content of the countermeasure and influence information regarding an influence of execution of the countermeasure on the evaluation of the performance, the productivity, and the cost.

6. The automation support device according to claim 2, wherein
in a case that all of the performance, the productivity, and the cost of the automation system of the second configuration satisfy the requirement specification information, the processor generates an operation scenario for the automation system of the second configuration to execute each process based on the automation system of the second configuration and the work procedure information.

7. An automation support method for supporting automation of a process included in work, the automation support method comprising:
acquiring work procedure information regarding a process for a person to work and requirement specification information regarding a specification required for an automation system including a robot device that executes the process;
determining a first configuration of the automation system based on the work procedure information;
evaluating performance, productivity, and a cost of the automation system of the first configuration based on the work procedure information and the requirement specification information; and
outputting first change support information for supporting a change in the first configuration of the automation system based on a result of the evaluation.
